(19) United States
(12) Patent Application Publication
(10) Pub. No.: US 2009/0316712 A1
(43) Pub. Date: Dec. 24, 2009

(54) Method and apparatus for minimizing clock drift in a VoIP communications network

(76) Inventors: John H. Shamilian, Tinton Falls, NJ (US); Thomas L. Wood, Colts Neck, NJ (US)

Correspondence Address: Lucent Technologies Inc.;Docket Administrator, Room 2F-192, 600 Mountain Avenue, Murray Hill, NJ, 07974-0636, US

(21) Appl. No.: 12/214,336

(22) Filed: Jun. 18, 2008

(51) Int. Cl. H04L 12/56; H04J 3/06

(52) U.S. Cl. 370/412; 370/503

(57) ABSTRACT

A method and apparatus for minimizing clock drift between un-synchronized clocks which may occur at opposing ends of a communication link established in, for example, a Voice over Internet Protocol (VoIP) communications network, especially for use with, for example, a FAX or modem terminal device. The illustrative system employs two or more clocks, wherein at least one of these clocks operates at an intentionally higher frequency than the nominal clock frequency (e.g., 8 kHz) and wherein at least one of these clocks operates at an intentionally lower frequency than the nominal clock frequency. In operation, the illustrative system alternatively chooses one of the clocks, in order to attempt to match the clock of the far-end terminal device on average. The state and/or history of the receiving device's associated jitter buffer may be advantageously used to determine which clock to select.

### FIELD OF THE INVENTION

The present invention relates generally to the field of communications networks which provide, for example, Voice over Internet Protocol (VoIP) communications services, and more particularly to a method and apparatus for minimizing clock drift which may occur at opposing ends of a communication link established in such a communications network.

### BACKGROUND OF THE INVENTION

Voice over Internet Protocol (VoIP) communications networks, like conventional telecommunications networks, assume the use of a standard speech sampling rate of 8 kHz (kiloHertz), which is the well known industry standard. In some VoIP systems, clock distribution techniques are used in order to guarantee a precise sampling rate of 8 kHz, but when communicating between systems and/or terminal devices that do not share the same clock, the sampling rate at one terminal device will, in general, not match that of the other.

This problem of inherent clock mismatch in VoIP systems that have terminal devices which do not share the same clock has largely been either ignored or worked-around. For voice calls with simple jitter buffers, voice distortion or other detrimental effects will usually not be noticeable as the clocks drift apart (i.e., as the difference between the near end and far end clocks increase). This is because such clock skew will typically only trigger a packet loss every few minutes, which may be easily adjusted on playback (if at all) by dropping individual voice samples at a constant rate. Moreover, with codecs that use silence suppression, most jitter buffers make the problem irrelevant by re-setting timing information after small periods of silence (assuming that the transmitting terminal does, in fact, occasionally transmit silence, which may not be the case when there are noisy connections).

However, modems and FAX machines were designed with the assumption of a very accurate and distributed clock system, such as that which exists in conventional telephone systems. They rely on re-creating a signal's frequency and timing information from the transmitted signal onto the receiver's modem. As such, the loss of even a single packet may have profound effects on the receiving modem. The loss may result in the complete loss of the communication within the modem protocol and a total failure of transmission of the data. Therefore, methods which may be fully adequate for voice calls are likely to be far less robust for FAX and modem calls, since these are far more sensitive to distortions in the frequency domain.

One possible work-around to this problem is to use a synchronizing distributed clock, but this is both expensive and may not be an available option in all systems. In addition, many large enterprise-based VoIP deployments require a special gateway to the PSTN (Public Switched Telephone Network), in order to handle FAX transmissions. And some VoIP deployments for smaller enterprises require a separate and completely independent POTS (Plain Old Telephone Service) line in order to support legacy FAX equipment. As such, most home VoIP users who wish to use a legacy FAX machine are either limited to a small number of pages per call, or must use an email-to-fax pay service.

### SUMMARY OF THE INVENTION

In accordance with various illustrative embodiments of the present invention, two or more clocks are used to supply data which has been received over a communications network to an illustrative terminal device (e.g., a FAX or modem used in a VoIP communications network), wherein at least one of these clocks operates at an intentionally higher frequency than the desired (“nominal”) clock frequency (e.g., 8 kHz), and wherein at least one of these clocks operates at an intentionally lower frequency than the desired (“nominal”) clock frequency. Then, in operation, an illustrative system in accordance with the present invention will advantageously alternatively choose one of the multiple clocks, in an attempt to effectively “match” the actual clock of the far-end terminal device on average. This will advantageously result in the same average sampling rate on both terminal ends (i.e., the near-end and the far-end terminals) of the VoIP session, eliminating the need to add or drop samples and leading to a truer signal reproduction, and thereby enabling legacy FAX and modem services to operate correctly without the need for additional hardware. The current state (e.g., the size) and/or the history of the state (e.g., a moving average size) of the receiving device's associated jitter buffer may be advantageously used to determine which clock to select.

Specifically, the present invention provides, for example, a method for receiving data transmitted over a packet-switched network, the received data for use by a communications network terminal device, the packet-switched network having a predetermined nominal clock frequency associated therewith, the terminal device having associated therewith a jitter buffer for storing said data received over said packet-switched network, the jitter buffer having a size which varies over time, the method comprising the steps of: monitoring the varying size of the jitter buffer; selecting a clock, based on the monitored size of the jitter buffer, the clock being selected from a set of two or more clocks associated with the jitter buffer, the set of clocks comprising at least a first clock having a first predetermined clock frequency and a second clock having a second predetermined clock frequency, the first predetermined clock frequency being less than the predetermined nominal clock frequency and the second predetermined clock frequency being greater than the predetermined nominal clock frequency; and using the selected clock to retrieve at least a portion of the data from the jitter buffer and provide it to the terminal device.

In addition, the present invention also provides, for example, an apparatus for receiving data transmitted over a packet-switched network having a predetermined nominal clock frequency associated therewith, the received data for use by an associated communications network terminal device, the apparatus comprising: a jitter buffer for storing data received over said packet-switched network, the jitter buffer having a size which varies over time; a set of two or more clocks comprising at least a first clock having a first predetermined clock frequency and a second clock having a second predetermined clock frequency, the first predetermined clock frequency being less than the predetermined nominal clock frequency and the second predetermined clock frequency being greater than the predetermined nominal clock frequency; and a clock selector which selects a clock from the set of two or more clocks, the clock selection being based on a monitored size of the jitter buffer, wherein the selected clock is used to retrieve at least a portion of the data from the jitter buffer and to provide it to the terminal device.

### BRIEF DESCRIPTION OF THE DRAWINGS

FIG. 1 shows an illustrative communications network which includes a FAX data transmission link to be performed partially over an VoIP network in accordance with an illustrative embodiment of the present invention.

FIG. 2 shows an illustrative FAX transmission occurring over a VoIP communications network in accordance with an illustrative embodiment of the present invention.

FIG. 3 shows a flowchart of a method which may be employed by a VoIP device using two or more clocks in accordance with an illustrative embodiment of the present invention.

### DETAILED DESCRIPTION OF THE PREFERRED EMBODIMENTS

### Overview of the Illustrative Embodiments of the Invention

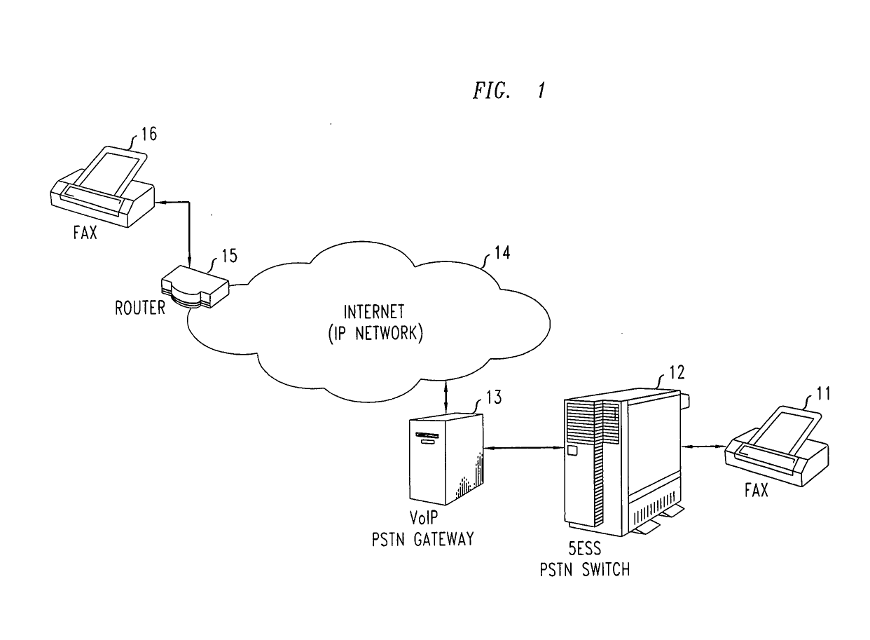

FIG. 1 shows an illustrative communications network which includes a FAX data transmission link to be performed partially over an VoIP network in accordance with an illustrative embodiment of the present invention. The figure shows FAX device 11 which is connected to a conventional telecommunications network and interfaces to the network via 5ESS PSTN (Public Switched Telephone Network) switch 12. The figure also shows FAX device 16, which is connected to the Internet (i.e., IP network 14) via VoIP home router 15, which receives packet data from the IP network and converts it to data samples which can be directly provided to the FAX. Finally, VoIP PSTN Gateway 13 provides an interface between the conventional (PSTN) telecommunications network and the Internet.

Note that, in general, VoIP data devices (such as VoIP home router 15) will often have a poor clock (i.e., having a frequency which may not be precise), and more importantly, one which has no synchronization to the clock being used by the conventional (PSTN) telecommunications network (and thus, in the illustrative example in the figure, by FAX 11). As such, the principles of the present invention may be advantageously employed in the environment shown in the figure, for example, by incorporating a method and apparatus in accordance with an illustrative embodiment of the present invention into VoIP home router 15, in order to advantageously synchronize the clock used by FAX 16 with the clock used by FAX 11. Moreover, since the same lack of clock synchronization applies in both directions, the principles of the present invention may also be advantageously employed in the environment shown in the figure, for example, by incorporating a method and apparatus in accordance with an illustrative embodiment of the present invention into VoIP PSTN Gateway 13, in order to advantageously synchronize the clock used by FAX 11 with the clock used by FAX 16.

### A First Illustrative Embodiment Using Two Clocks and Jitter Buffer Size Thresholds

In accordance with one illustrative embodiment of the present invention, a VoIP data device (which may, for example, be connected to a FAX or a modem—either directly or indirectly through a communications network) employs two clocks, one of which operates at an intentionally higher frequency than the desired (“nominal”) clock frequency (e.g., 8 kHz) and the other which operates at an intentionally lower frequency than the desired (“nominal”) clock frequency (e.g., 8 kHz). For example, the two clocks may illustratively operate at frequencies of 8.1 kHz and 7.9 kHz, respectively. In typical VoIP systems (as well as in, for example, typical packet based video systems), each terminal end of a transmission is supplied with a jitter buffer, which is fully familiar to those of ordinary skill in the art. In accordance with certain illustrative embodiments of the present invention, the jitter buffer may be advantageously employed by the VoIP device to determine which of these two clocks is to be used at any given point in time.

Specifically, a jitter buffer is a queue which is advantageously used to store packets of received data before the “playout” of the data (i.e., the processing of the received data by the terminal to, for example, present the received data to the user of the terminal in the appropriate form). As such, the amount of data stored (i.e., queued) in the jitter buffer varies over time. Jitter buffers are most advantageously used in packet based networks, such as, for example, IP (Internet Protocol) networks, in order to compensate for the variability in the network transmission time for the different packets which comprise the communication stream. Typically, the total capacity (i.e., the maximum size) of the jitter buffer is sufficiently large so that “worst-case” packet transmission times through the network may be handled. The number of samples which are in the jitter buffer at a given point in time is said to be the current “size” of the jitter buffer.

In a communications system with precisely matched clocks at the two ends of a communication link (i.e., when the frequency of the clock used by the transmitting terminal exactly matches the frequency of the clock used by the receiving terminal), the jitter buffer will be of a fairly stable size on average—that is, it will not tend to grow or shrink in average size over time, except that it will vary around that average size, as a result of the aforementioned variability in the network transmission times of the packets being sent and received as part of the given communication stream. However, in a system with mismatched clocks, the jitter buffer's average size will tend to grow (if the frequency of the receiving device's clock is lower than the frequency of the transmitting device's clock) or shrink (if the frequency of the receiving device's clock is higher than the frequency of the transmitting device's clock). This is because either more samples will be received during a given time interval than will be played out (if the frequency of the receiving device's clock is lower than the frequency of the transmitting device's clock), or more samples will be played out during a given time interval than will be received (if the frequency of the receiving device's clock is higher than the frequency of the transmitting device's clock), respectively.

Specifically, then, in accordance with a first illustrative embodiment of the present invention, in which a VoIP data device employs two clocks, one of which operates at an intentionally higher frequency than the desired (nominal) clock frequency (e.g., 8 kHz) and the other which operates at an intentionally lower frequency than the desired (nominal) clock frequency (e.g., 8 kHz), the (current) size of the jitter buffer is advantageously monitored. Then, when the size of the jitter buffer exceeds a predetermined “high water mark” (i.e., when the size of the jitter buffer is greater than a predetermined threshold), the faster one of these two clocks (i.e., the clock which operates at an intentionally higher frequency than the nominal clock frequency) is advantageously selected for use by the VoIP device for playout of the samples stored in the jitter buffer. Similarly, when the size of the jitter buffer becomes less than a predetermined “low water mark” (i.e., when the size of the jitter buffer is less than another predetermined threshold), the slower one of these two clocks (i.e., the clock which operates at an intentionally lower frequency than the nominal clock frequency) is advantageously selected for use by the VoIP device for playout of the samples stored in the jitter buffer. Advantageously, the predetermined threshold used for the “high water mark” is greater than the other predetermined threshold used for the “low water mark,” in order to avoid excessive (and unnecessary) switching between clocks.

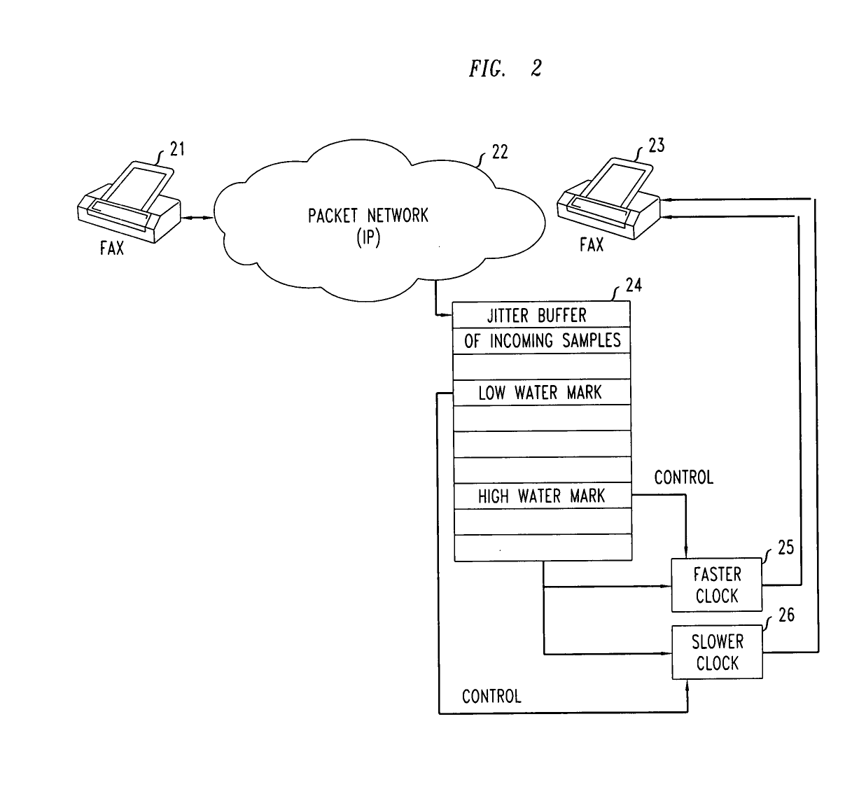

FIG. 2 shows an illustrative FAX transmission occurring over a VoIP communications network in accordance with an illustrative embodiment of the present invention. The figure shows FAX 21, which is transmitting data through (IP) packet network 22 to FAX 23. FAX 23 advantageously has associated therewith jitter buffer 24, as well as “faster” clock 25 and “slower” clock 26 (which may, for example, each be incorporated into a VoIP home router connected to the packet network, such as, for example, VoIP home router 15 of FIG. 1). As can be seen in the figure, although the size of jitter buffer 24 may vary over time, there is a predetermined “high water mark” and a predetermined “low water mark” associated therewith. When the size of jitter buffer 24 exceeds the “high water mark” (indicating that the jitter buffer is relatively full), “faster” clock 25 is selected for use in retrieving data from the jitter buffer and providing it to FAX 23. When the size of jitter buffer 24 becomes less than the “low water mark” (indicating that the jitter buffer is relatively empty), “slower” clock 26 is selected for use in retrieving data from the jitter buffer and providing it to FAX 23.

In accordance with this illustrative embodiment of the invention, when the faster clock is selected, the VoIP device will advantageously begin to consume more samples per unit time than the nominal average number of samples per unit time (e.g., 8,000 samples per second, given that the nominal clock frequency is 8 kHz), whereas when the slower clock is selected, the VoIP device will advantageously begin to consume fewer samples per unit time than the nominal average number of samples per unit time (e.g., 8,000 samples per second, given that the nominal clock frequency is 8 kHz). By “switching” the selected clock between the faster clock and the slower clock as needed, the VoIP device advantageously avoids the need to add or drop samples (or packets) in order to keep the jitter buffer size within an acceptable range. Rather, since the faster clock is selected whenever the jitter buffer grows “too large,” and since the slower clock is selected whenever the jitter buffers grows “too small,” this keeps the jitter buffer size within a desired range, and thus advantageously keeps the clock of the VoIP device which is receiving the data relatively synchronized, on average, with the clock of the VoIP device which is sending the data. (Note that the net effect of using the faster or slower clock is to slightly shorten or slightly elongate, respectively, the individual sample's represented time interval, so that it more closely matches the effective sample rate of the far-end VoIP device.)

### A Second Illustrative Embodiment Using Two Clocks & Jitter Buffer Size Averages

In accordance with another illustrative embodiment of the present invention, the history of the jitter buffer size may be advantageously used to determine when to switch between two clocks—one operating at an intentionally higher frequency than the nominal clock frequency (e.g., 8 kHz) and the other operating at an intentionally lower frequency than the nominal clock frequency (e.g., 8 kHz). For example, rather than selecting the faster clock whenever the jitter buffer size is greater than a predetermined threshold and selecting the slower clock whenever the jitter buffer size is less than another predetermined threshold (as in the first illustrative embodiment of the present invention described above), a moving average of the jitter buffer size may be advantageously computed and the clock selection may be made based on the value of this moving average (rather than on the current absolute value of the jitter buffer size).

For example, in accordance with a second illustrative embodiment of the present invention, in which a VoIP data device employs two clocks, one of which operates at an intentionally higher frequency than the nominal clock frequency (e.g., 8 kHz) and the other which operates at an intentionally lower frequency than the nominal clock frequency (e.g., 8 kHz), a moving average size of the jitter buffer is advantageously computed and monitored. (Moving averages and the computation thereof are fully familiar to those of ordinary skill in the art.) Then, when this computed moving average size of the jitter buffer exceeds a predetermined “high water mark” (i.e., when the computed moving average size of the jitter buffer is greater than a predetermined threshold), the faster one of these two clocks (i.e., the clock which operates at an intentionally higher frequency than the nominal clock frequency) is advantageously selected for use by the VoIP device for playout of the samples stored in the jitter buffer. Similarly, when this computed moving average size of the jitter buffer becomes less than a predetermined “low water mark” (i.e., when the computed moving average size of the jitter buffer is less than another predetermined threshold), the slower one of these two clocks (i.e., the clock which operates at an intentionally lower frequency than the nominal clock frequency) is advantageously selected for use by the VoIP device for playout of the samples stored in the jitter buffer. Advantageously, the predetermined threshold used for the “high water mark” is greater than the other predetermined threshold used for the “low water mark,” in order to avoid excessive and unnecessary switching between clocks.

Note that by using a (computed) moving average of the jitter buffer size, rather than the absolute current value of the jitter buffer size, natural variability in the jitter buffer size resulting from the typically variable network transmission delays will advantageously not cause the VoIP device to switch between the two clocks, thereby avoiding such clock switching unnecessarily and with excessive frequency. Rather, only when the jitter buffer size grows or shrinks on average, as a result of mismatched clock frequencies—not simply transmission delays, will the VoIP device be likely to switch to the other clock.

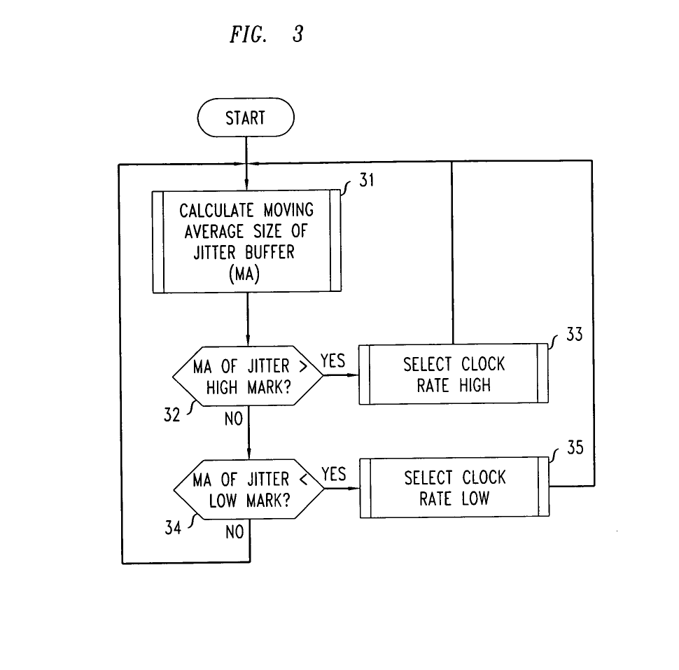

FIG. 3 shows a flowchart of a method which may be employed by a VoIP device using two or more clocks in accordance with an illustrative embodiment of the present invention. In accordance with the illustrative flowchart, which comprises a continuous loop, a moving average size of the jitter buffer is calculated in block 31. Then, if the calculated moving average size exceeds a predetermined “high water mark” (as determined in decision block 32 of the flowchart), the “faster” clock is selected (in block 33) for use in retrieving data from the jitter buffer, and then flow returns to block 31 to recalculate the moving average size of the jitter buffer. Otherwise, flow proceeds to decision block 34, which determines if the calculated moving average size is less than a predetermined “low water mark,” and if so, the “slower” clock is selected (in block 35) for use in retrieving data from the jitter buffer, and flow then returns to block 31 to recalculate the moving average size of the jitter buffer. If not (i.e., the moving average size of the jitter buffer is neither greater than the predetermined “high water mark” nor lower than the predetermined “low water mark”), then no change is made to the selected clock and flow returns to block 31 to recalculate the moving average size of the jitter buffer. (In this latter case, no change is made to the selected clock since the calculated moving average size must necessarily lie between the “high water mark” and the “low water mark.”)

### A Third Illustrative Embodiment Using More Than Two Clocks

In accordance with other illustrative embodiments of the present invention, three or more clocks, each having a different frequency than each of the others, are advantageously employed by a VoIP device, wherein at least one of these clocks operates at an intentionally higher frequency than the nominal clock frequency (e.g., 8 kHz) and wherein at least one of these clocks operates at an intentionally lower frequency than the nominal clock frequency (e.g., 8 kHz). For example, in accordance with a third illustrative embodiment of the present invention, three clocks are advantageously employed by a VoIP device, wherein the three clocks illustratively operate at frequencies of 8.1 kHz (the highest rate clock), 8.0 kHz (the nominal rate clock), and 7.9 kHz (the lowest rate clock), respectively.

In accordance with this third illustrative embodiment of the present invention, the VoIP device advantageously monitors either the size of the jitter buffer (as in the above-described first illustrative embodiment of the present invention) or a computed moving average thereof (as in the above-described second illustrative embodiment of the present invention), and advantageously switches from using the “current” one of its three (or, in the case of other illustrative embodiments of the present invention, four or more) available clocks to another clock based upon the jitter buffer (i.e., based upon the size or the moving average size thereof). In particular, and by way of example, when the monitored value (i.e., the size or moving average size of the jitter buffer) exceeds the “high water mark” (i.e., when the monitored value is determined to be greater than a predetermined threshold), the VoIP device switches from whichever clock it is currently using to the “next” faster one of its available clocks. For example, if the VoIP device has three clocks operating at frequencies of 8.1 kHz (the highest rate clock), 8.0 kHz (the nominal rate clock), and 7.9 kHz (the lowest rate clock), and if the VoIP device is currently using the 7.9 kHz clock when it is determined that the monitored value has exceeded the predetermined threshold, then the VoIP device advantageously switches to the 8.0 kHz clock, since that is the next faster clock than the 7.9 kHz clock. However, if the illustrative VoIP device having these 3 clocks (7.9 kHz, 8.0 kHz and 8.1 kHz) is currently using the 8.0 kHz clock when it is determined that the monitored value has exceeded the predetermined threshold, then the VoIP device advantageously switches to the 8.1 kHz clock, since that is the next faster clock than the 8.0 kHz clock.

Similarly, and also by way of example, when the monitored value (i.e., the size or moving average size of the jitter buffer) becomes less than the “low water mark” (i.e., when the monitored value is determined to be less than another predetermined threshold), the VoIP device switches from whichever clock it is currently using to the “next” slower one of its available clocks. For example, if the VoIP device has three clocks operating at frequencies of 8.1 kHz (the highest rate clock), 8.0 kHz (the nominal rate clock), and 7.9 kHz (the lowest rate clock), and if the VoIP device is currently using the 8.1 kHz clock when it is determined that the monitored value is less than the other predetermined threshold, then the VoIP device advantageously switches to the 8.0 kHz clock, since that is the next slower clock than the 8.1 kHz clock. However, if the illustrative VoIP device having these 3 clocks (7.9 kHz, 8.0 kHz and 8.1 kHz) is currently using the 8.0 kHz clock when it is determined that the monitored value is less than the other predetermined threshold, then the VoIP device advantageously switches to the 7.9 kHz clock, since that is the next slower clock than the 8.0 kHz clock. Advantageously, the predetermined threshold used for the “high water mark” is greater than the other predetermined threshold used for the “low water mark,” in order to avoid excessive and unnecessary switching between clocks.

As will be obvious to those of ordinary skill in the art, the above-described illustrative embodiment of the present invention can be easily generalized to use any number of clocks greater than three. In any such case, when using three or more clocks, the illustrative VoIP device will advantageously be expected to (ultimately) alternate between an “adjacent” pair of these clocks (i.e., clocks having frequencies which are adjacent to each other, relative to the set of clock frequencies available to the VoIP device), and it can then be surmised that the actual frequency of the clock at the other end (ie., the far end) of the transmission channel is somewhere in between the two frequencies of these two adjacent (and surrounding) clocks.

### Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. For example, although the illustrative embodiments described above have been directed to VoIP system environments, the principles of the present invention can be applied equally well to systems which transmit video or other data whenever the sampling rates of the near-end and far-end clocks may not be exactly matched. Moreover, while the benefits of the instant invention may be most clear when applied to modem and FAX signals, the invention may also be advantageously applied to systems for voice, video and multimedia listening and/or viewing as well, in order to provide the best possible experience therewith.

In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for receiving data transmitted over a packet-switched network, the received data for use by a communications network terminal device, the packet-switched network having a predetermined nominal clock frequency associated therewith, the terminal device having associated therewith a jitter buffer for storing said data received over said packet-switched network, the jitter buffer having a size which varies over time, the method comprising the steps of:
monitoring the varying size of the jitter buffer;
selecting a clock, based on the monitored size of the jitter buffer, the clock being selected from a set of two or more clocks associated with the jitter buffer, the set of clocks comprising at least a first clock having a first predetermined clock frequency and a second clock having a second predetermined clock frequency, the first predetermined clock frequency being less than the predetermined nominal clock frequency and the second predetermined clock frequency being greater than the predetermined nominal clock frequency; and
using the selected clock to retrieve at least a portion of the data from the jitter buffer and provide it to the terminal device.

2. The method of claim 1 wherein the packet-switched network comprises a Voice over Internet Protocol (VoIP) network and wherein the predetermined nominal clock frequency is equal to 8 kiloHertz.

3. The method of claim 2 wherein the terminal device comprises a FAX.

4. The method of claim 2 wherein the terminal device comprises a modem.

5. The method of claim 1 wherein the step of selecting a clock comprises selecting a clock based on a current size of the jitter buffer.

6. The method of claim 5 wherein the step of selecting a clock further comprises
(i) selecting the first clock when the current size of the jitter buffer is less than a first predetermined threshold, and
(ii) selecting the second clock when the current size of the jitter buffer is greater than a second predetermined threshold,
where the first predetermined threshold is less than the second predetermined threshold.

7. The method of claim 1 wherein the step of selecting a clock comprises selecting a clock based on a moving average size of the jitter buffer.

8. The method of claim 7 wherein the step of selecting a clock further comprises
(i) selecting the first clock when the moving average size of the jitter buffer is less than a first predetermined threshold, and
(ii) selecting the second clock when the moving average size of the jitter buffer is greater than a second predetermined threshold,
where the first predetermined threshold is less than the second predetermined threshold.

9. The method of claim 7 wherein the set of clocks comprises three or more clocks each having a different predetermined clock frequency, and wherein the step of selecting a clock comprises
(i) selecting a clock having a next lower clock frequency than the one of said three or more clocks which has most recently been used to retrieve at least a portion of the data from the jitter buffer, when the moving average size of the jitter buffer is determined to be less than a first predetermined threshold, and
(ii) selecting a clock having a next higher clock frequency than the one of said three or more clocks which has most recently been used to retrieve at least a portion of the data from the jitter buffer, when the moving average size of the jitter buffer is determined to be greater than a second predetermined threshold,
where the first predetermined threshold is less than the second predetermined threshold.

10. The method of claim 9 wherein one of said three or more clocks has a clock frequency which is approximately equal to the predetermined nominal clock frequency.

11. An apparatus for receiving data transmitted over a packet-switched network having a predetermined nominal clock frequency associated therewith, the received data for use by an associated communications network terminal device, the apparatus comprising:
a jitter buffer for storing data received over said packet-switched network, the jitter buffer having a size which varies over time;
a set of two or more clocks comprising at least a first clock having a first predetermined clock frequency and a second clock having a second predetermined clock frequency, the first predetermined clock frequency being less than the predetermined nominal clock frequency and the second predetermined clock frequency being greater than the predetermined nominal clock frequency; and
a clock selector which selects a clock from the set of two or more clocks, the clock selection being based on a monitored size of the jitter buffer,
wherein the selected clock is used to retrieve at least a portion of the data from the jitter buffer and to provide it to the terminal device.

12. The apparatus of claim 11 wherein the packet-switched network comprises a Voice over Internet Protocol (VoIP) network and wherein the predetermined nominal clock frequency is equal to 8 kiloHertz.

13. The apparatus of claim 12 wherein the terminal device comprises a FAX.

14. The apparatus of claim 12 wherein the terminal device comprises a modem.

15. The apparatus of claim 11 wherein the clock selector selects a clock based on a current size of the jitter buffer.

16. The apparatus of claim 15 wherein the clock selector
(i) selects the first clock when the current size of the jitter buffer is less than a first predetermined threshold, and
(ii) selects the second clock when the current size of the jitter buffer is greater than a second predetermined threshold,
where the first predetermined threshold is less than the second predetermined threshold.

17. The apparatus of claim 11 wherein the clock selector selects a clock based on a moving average size of the jitter buffer.

18. The apparatus of claim 17 wherein the clock selector
(i) selects the first clock when the moving average size of the jitter buffer is less than a first predetermined threshold, and
(ii) selects the second clock when the moving average size of the jitter buffer is greater than a second predetermined threshold,
where the first predetermined threshold is less than the second predetermined threshold.

19. The apparatus of claim 17 wherein the set of clocks comprises three or more clocks each having a different predetermined frequency, and wherein the clock selector
(i) selects a clock having a next lower frequency than the one of said three of more clocks which has most recently been used to retrieve at least a portion of the data from the jitter buffer, when the moving average size of the jitter buffer is less than a first predetermined threshold, and
(ii) selects a clock having a next higher frequency than the one of said three of more clocks which has most recently been used to retrieve at least a portion of the data from the jitter buffer, when the moving average size of the jitter buffer is greater than a second predetermined threshold,
where the first predetermined threshold is less than the second predetermined threshold.

20. The apparatus of claim 19 wherein one of said three or more clocks has a frequency which is approximately equal to the predetermined nominal clock frequency.
